(19) United States
(12) Patent Application Publication
(10) Pub. No.: US 2025/0283996 A1
(43) Pub. Date: Sep. 11, 2025

(54) Method for Operating a Measuring Device

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Heiko Sgarz, Leonberg (DE); Jan Linus Steuler, Woelfersheim (DE); Judith Borowski, Ho Chi Minh City (VN); Lukas Fiederer, Balingen (DE); Uwe Troeltzsch, Roesrath (DE)

(21) Appl. No.: 19/071,101

(22) Filed: Mar. 5, 2025

(30) Foreign Application Priority Data
Mar. 11, 2024 (DE) 10 2024 202 231.4

(51) Int. Cl. G01S 13/88; G01S 7/40; G01S 7/41; G01S 13/08; G01S 13/86

(52) U.S. Cl. CPC G01S 13/888; G01S 7/4004; G01S 7/41; G01S 13/08; G01S 13/86

(57) ABSTRACT

A computer-implemented method for operating a measuring device, in particular a wall diagnostic device includes (i) receiving radar data of a radar sensor unit of the measuring device, (ii) performing wall diagnostics by performing an analysis of the radar data and providing diagnostic results via a diagnostic module of the measuring device, (iii) providing, by way of the diagnostic module, the diagnostic results to a display unit of the measuring device, and (iv) displaying the diagnostic results in the display unit.

This application claims priority under 35 U.S.C. § 119 to application no. DE 10 2024 202 231.4, filed on Mar. 11, 2024 in Germany, the disclosure of which is incorporated herein by reference in its entirety.

The present disclosure relates to a method for operating a measuring device, in particular a wall diagnostic device.

### BACKGROUND

Diagnostic devices for performing wall diagnostics and detecting objects formed in the walls are known from prior art.

A task of the present disclosure to provide an improved method for operating a measuring device, in particular a wall diagnostic device.

The task is solved by the method set forth below. Advantageous embodiments are subject-matter also set forth below.

### SUMMARY

According to one aspect, a computer-implemented method of operating a measuring device, in particular a wall diagnostic device is provided, wherein the method comprises:
receiving radar data from a radar sensor unit of the measuring device, wherein the radar data depicts a wall on which diagnostics are to be performed;
performing wall diagnostics by performing an analysis of the radar data and providing diagnostic results via a diagnostic module of the measuring device, wherein the wall diagnostics comprise:
performing a wall type classification and determining a wall type of the wall by way of the diagnostic module, wherein the diagnostic results comprise at least the wall type of the wall;
providing the diagnostic results via the diagnostic module to a display unit of the measuring device; and
displaying the diagnostic results in the display unit.

The technical advantage can thereby be achieved that an improved method for operating a measuring device, in particular a wall diagnostic device, can be provided. For this purpose, radar data of a sensor unit of the measuring device is first received. The radar data depicts the wall on which diagnostics are to be performed. Furthermore, wall diagnostics are performed by a diagnostic module based on the radar data, and diagnostic results are provided. The wall diagnostics comprise at least determining a wall type of the wall on which diagnostics are to be performed, wherein the determined wall type is displayed as the diagnostic result in a display unit of the measuring device. With the present method, an automatic determination of a wall type of the wall on which diagnostics are to be performed may be provided based solely on radar data of a radar sensor unit. By automatically determining the wall type, a manual selection of the wall type of the wall to be examined by a user of the measuring device can be avoided. The wall type determined in the automatic wall type classification or automatic determination of the wall type can be further used in additional steps of the wall diagnostics, for example as background correction for an executed object recognition. This may further improve the quality of the wall diagnostics.

According to one embodiment, the wall diagnostics further comprise:
determining uncertainty values for the diagnostic results by way of the diagnostic module, wherein the uncertainty values for the diagnostic results describe probability values that the diagnostic results match an actual state of the wall on which diagnostics are performed, and comprise at least one probability value for the wall type of the wall; and wherein the method further comprises:
providing the uncertainty values along with the diagnostic results to a display unit using the diagnostic module; and
displaying the uncertainty values along with the diagnostic results in the display unit.

The technical advantage can thereby be achieved that additional information from the wall diagnostics can be provided to the user of the measuring device by determining uncertainty values of the diagnostic results, in particular the wall type determined in the wall diagnostics, and by providing and displaying the uncertainty values together with the diagnostic results on the display unit. The user can thus assess the diagnostic results based on the uncertainty values and can thus better adapt the further procedure when working on the wall to the executed wall diagnostics. If diagnostic results with a high uncertainty value are displayed, the user can assume that there is a high probability that the determined diagnostic result corresponds to an actual state of the wall to be examined. With low uncertainty values, the user can assume, on other hand, that the determined diagnostic results only reflect the actual state of the wall with a low probability. Taking into account the uncertainty values, the user can adjust the further procedure or the further work on the wall to the diagnostic results of the wall diagnostics. According to the disclosure, the uncertainty values describe probabilities for the accuracy of the provided diagnostic results.

According to one embodiment, a plurality of possible wall types of the wall will be determined as stand-alone diagnostic results in the wall type classification, wherein a probability value is determined for each of the plurality of wall types of the wall, and wherein the plurality of wall types of the wall are displayed as diagnostic results and the plurality of probability values of the different wall types are displayed as corresponding uncertainty values of the diagnostic results in the display unit.

The technical advantage can thereby be achieved that improved quality of the wall diagnostics is facilitated. For this purpose, a plurality of possible wall types of the wall are determined as stand-alone diagnostic results in the wall type classification. The respective different wall types are each provided with uncertainty values, which indicate a probability value that the respective wall type corresponds to the actual wall type of the wall to be examined. The user can evaluate the plurality of wall types displayed and decide which of the indicated wall types corresponds to the actual wall type of the wall to be examined.

According to one embodiment, the method further comprises:
providing a first selection function, wherein at least one of the displayed wall types is selectable by performing the first selection function by a user of the measuring device.

The technical advantage can thereby be achieved that the selection function enables the user to select at least one of the plurality of displayed wall types as the actual wall type of the wall to be examined. The user thus has the option of incorporating their own knowledge of the wall to be examined into the wall diagnostics. Further improvement of the wall diagnostics can thereby be achieved.

According to one embodiment, the method further comprises:
providing a second selection function, wherein, by the user of the measuring device performing the second selection function, automatic determination of the wall type during wall diagnostics and/or display of the wall type in the display unit can be deactivated, and a wall type is manually selectable by the user.

The technical advantage can thereby be achieved that, by way of the second selection function, the user can deactivate the automatic determination of the wall type and can manually select a wall type. The user can thus manually enter the actual wall type of the wall to be examined based on knowledge of the actual wall type, in order to further improve the wall diagnostics, especially in the event that the automatic wall type determination did not determine the actual wall type and thus provides an insufficient result. The wall type entered by the user can be used for further steps of wall diagnostics. This may further improve the quality of the wall diagnostics.

According to one embodiment, the method further comprises:
displaying a plurality of possible wall types in the second selection function, wherein the user can select at least one of the displayed possible wall types in the second selection function.

The technical advantage can thereby be achieved that the wall diagnostics can be further improved. For this purpose, the user can select at least one of the multiple wall types indicated. This may improve matching the automatically determined wall type to the actual wall type present.

According to one embodiment, the wall diagnostics further comprise:
performing an object recognition of an object located in the wall using the diagnostic module, wherein the object recognition comprises an object detection and an object classification, and wherein the diagnostic results comprise at least one object position in the wall and/or one object type of the object; and/or
performing an object depth determination and determining an object depth of the object in the wall using the diagnostic module, wherein the object depth is defined as a distance of the object to a surface of the wall; and/or
performing, by way of the diagnostic module, an object extension determination and determining an object extension of the object along a predefined direction, wherein the diagnostic results further comprise the object position in the wall and/or the object type and/or the object depth and/or the object extension of the object, and wherein the uncertainty values further comprise at least one probability value of the object position and/or a probability value of the object type and/or a probability value of the object depth and/or a probability value of the object extension of the object.

The technical advantage can thereby be achieved that the wall diagnostics can be further improved. For this purpose, in addition to determining the wall type, an object recognition including an object detection with a determination of an object position and an object classification with a determination of an object type is performed. Furthermore, an object depth and an object extension of an object located in the wall may be determined and provided as corresponding diagnostic results and displayed in the display unit.

According to one embodiment, the method further comprises:
receiving selection commands from the user, wherein a wall type is selected by the user in the first or second selection function by the selection commands;
determining, by way of the diagnostic module, the probability value of the selected wall type based on the radar data; and
displaying the wall type for which the greatest probability value was determined based on the radar data if the probability value of the wall type selected by the user falls below a predetermined threshold value; and/or
considering the wall type selected by the user in the second selection function for object recognition and/or object depth determination and/or object extension determination if the probability value of the selected wall type reaches or exceeds the predefined limit value; and/or
considering, by way of the diagnostic module, the automatically determined wall type based on the radar data with the greatest probability value for object recognition and/or object depth determination and/or object extension determination.

The technical advantage can thereby be achieved that improved wall diagnostics are facilitated. If the user activates the second selection function and deactivates the automatic determination of the wall type and manually selects a wall type, the wall type manually entered by the user is only used for further wall diagnostics if the wall type entered has a probability value that reaches or exceeds a predefined threshold value. Otherwise, a wall type determined by the automatic wall type determination is used for the further wall diagnostics. This can prevent the subsequent wall diagnostics from being negatively affected by incorrect manual input of the wall type by the user.

According to one embodiment, the measuring device further comprises at least one of an induction sensor and/or an eddy current sensor and/or a capacitance sensor and/or an AC current sensor and/or an NMR sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics or the object recognition.

According to one embodiment, the diagnostic module comprises at least one correspondingly trained artificial intelligence configured to perform an object recognition and/or wall classification and/or object depth determination based on the radar data and/or the additional sensor data

The technical advantage can thereby be achieved that, because the diagnostic module is configured as a correspondingly trained artificial intelligence structure, which is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technology, precise wall diagnostics can be provided.

According to one embodiment, the object classes of the object type of the object comprise: metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, and/or wherein the wall type classes of the wall comprise: Concrete wall, plasterboard/drywall wall, brick wall and/or bricks of the wall, underfloor heating, wall heating.

The technical advantage may thereby be achieved that objects and walls of different types may be detected and classified.

According to one aspect, a method for training an artificial intelligence structure of a wall diagnostic measuring device is provided, comprising:
providing a training dataset for training an artificial intelligence, wherein the training dataset comprises a wall and radar data depicting an object formed in the wall as well as the feedback information provided according to the method for operating a measuring device;
training the artificial intelligence based on the training dataset and taking into account the feedback information to perform object recognition of an object formed in a wall, wherein the object recognition comprises at least one object detection and one object classification.

The technical advantage can thereby be achieved that improved training of the artificial intelligence of the wall diagnostic device, in particular post-training, is facilitated, by way of which feedback is taken into account by the user of the wall diagnostic devices.

According to one aspect, a computing unit is provided, which is configured to perform the method for operating a measuring device according to one of the preceding embodiments.

According to one aspect, a computer program product is provided comprising instructions that, when the program is executed by a data processing unit, cause the data processing unit to perform the method for operating a measuring device according to one embodiment.

### BRIEF DESCRIPTION OF THE DRAWINGS

Embodiments of the disclosure are described with reference to the following figures. The figures show:

FIG. 1 a schematic representation of a measuring device according to one embodiment;

FIG. 2 a further schematic representation of the measuring device according to a further embodiment;

FIG. 3 a further schematic representation of the measuring device according to a further embodiment;

FIG. 4 a schematic representation of a measurement of the measuring device according to one embodiment,

FIG. 5 a further schematic representation of the measuring device according to a further embodiment;

FIG. 6 a schematic representation of a system for operating a measuring device according to one embodiment,

FIG. 7 a flowchart of a method for operating a measuring device according to one embodiment,

FIG. 8 another flowchart of the method for operating a measuring device according to a further embodiment,

FIG. 9 another flowchart of the method for operating a measuring device according to a further embodiment,

FIG. 10 another flowchart of the method for operating a measuring device according to a further embodiment, and

FIG. 11 a schematic representation of a computer program product.

### DETAILED DESCRIPTION

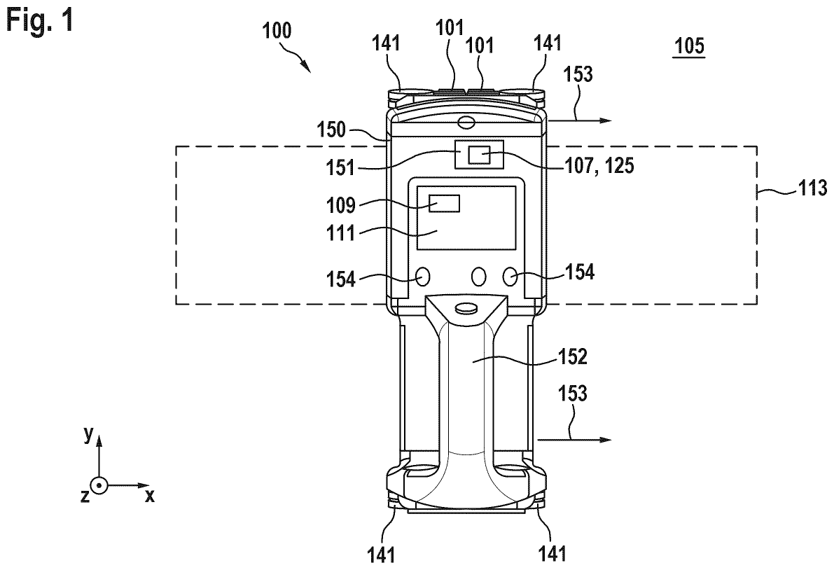

FIG. 1 shows a schematic representation of a measuring device 100 according to one embodiment.

The present disclosure relates to a measuring device, in particular a wall diagnostic device for examining walls 105 to be worked on. Wall diagnostic devices are known from prior art that are used to detect objects located in walls. Such devices allow a user to examine walls to be worked on to search for objects located in the walls, in order to be able to perform planned work, for example drilling in walls, such that damage to the objects located in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 between various operating modes.

According to the disclosure, the measuring device 100 comprises at least one radar sensor unit 101. By way of the radar sensor unit 101, radar signals may be transmitted towards the wall 105 to be examined, and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform corresponding diagnostics on the wall to be examined based on the radar data 103 of the radar sensor unit 101. The radar data 103 of the radar sensor unit 101 thereby depicts the wall 105 to be examined and, if applicable, objects 113 located within the wall 105.

The wall diagnostics carried out by the diagnostic module 107 comprise at least performing object recognition. The object recognition comprises an object detection and an object classification of the object 113 located in the wall 105. The object detection comprises at least the determination of an object position 115. The object position describes the positioning of the object located in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 located in the wall 105, are subsequently presented in a display unit 111 of the measuring device 100 to a user of the measuring device 100. For example, the display unit 111 may be configured as a corresponding display, and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105, and radar signals reflected from the wall 105 or the objects 113 located behind it are received, via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 located in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-mentioned wall diagnostics based on the radar data 103 of the radar sensor unit 101 and to determine at least the object position 115 and the object type 117 of an object 113 located in the wall 105. The object classification or determination of the object type 117, respectively, comprises assigning the detected object 113 to predefined object classes.

The object classes may comprise: Metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, or other elements commonly installed in building walls.

Furthermore, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can particularly be used for object recognition of the objects 113 located in the walls 105. The additional sensor information may possibly provide improved detection of the objects 113 and may possibly provide improved classification of the objects 113.

For example, the material of the objects 113, for example as a metallic or non-metallic material, can be particularly improved and classified by using the additional sensor information.

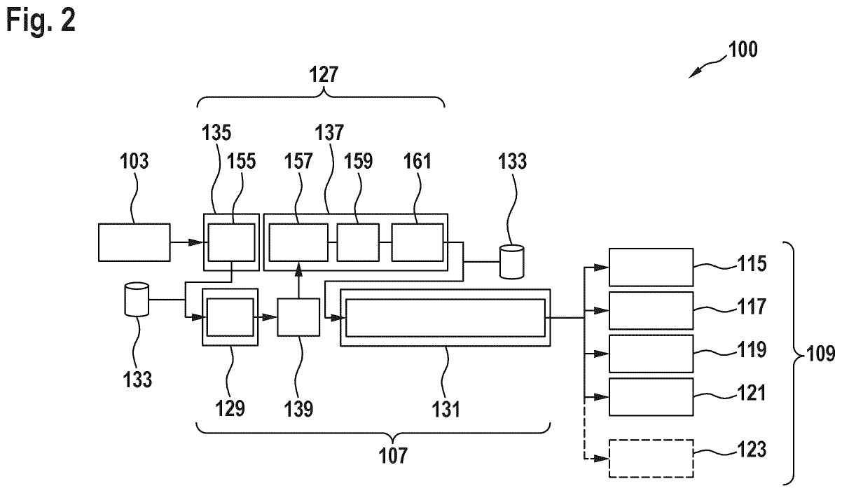

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing by the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be considered during the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. During the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects can occur on the radar data 103.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs object recognition of the object 113 located in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed
radar echoes of different frequencies may be used as radar data 103 and as input data for the diagnostic module 107. Alternatively, radar data 103 processed via multiple steps may be used. The pre-processing steps comprise, for example, the transformation of the
signals from the frequency domain to the time or distance domain, background deduction, noise removal, and normalization of the signals. For radar data 103 which is available in the form of complex numbers, only the absolute value can be processed. Alternatively or additionally, the phase information may be considered.

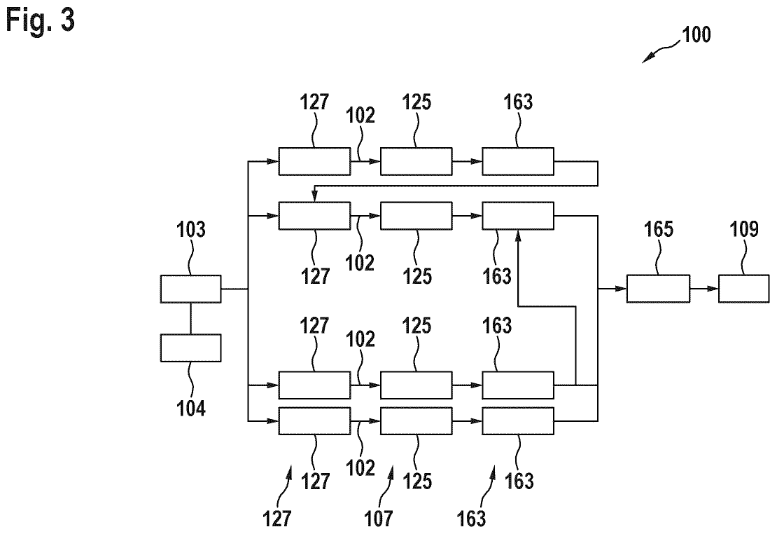

FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, comprising the wall type classification module 129 and/or the object recognition module 131, for example, according to the embodiment in FIG. 2, and a post-processing module 163.

In FIG. 3, primarily the radar data 103 is shown as input data for the wall diagnostics. In addition to the radar data shown, however, the additional information from the additional sensors may also serve as input data for the wall diagnostics. The different information from the different types of sensors in the different parallel processing paths 102 can be processed and the corresponding wall diagnostics performed separately on the different sensor information. Upon completion of the wall diagnostics, a summary module may be used to assemble a summary of the individual partial analysis results for the diagnostic results 109 of the wall diagnostics.

Alternatively or additionally, different sub-aspects of wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moves relative to the wall 105, may then be processed in the different processing paths 102 by the modules shown.

The various processing paths perform stand-alone wall diagnostics including at least determining the object position 115 and/or the object type 117 of the object 113 located in the wall 105.

By way of the summary module 165, the partial results of the stand-alone wall diagnostics of the different regions of the wall 105 provided in the individual processing paths 102 can be summarized to a contiguous diagnostic result 109. The contiguous diagnostic result describes the wall diagnostics of a contiguous spatial area that was scanned during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object 113 located in the wall can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may each be carried out. In the summary module 165, the various partial results of the wall diagnostics may be summarized into corresponding diagnostic results 109.

The diagnostic module 107 can be divided into different artificial intelligence structures 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligence structures 125, for example, neural networks. Alternatively, the various modules may form portions of an overall artificial neural network that are connected to an overall neural network according to structures known from prior art.

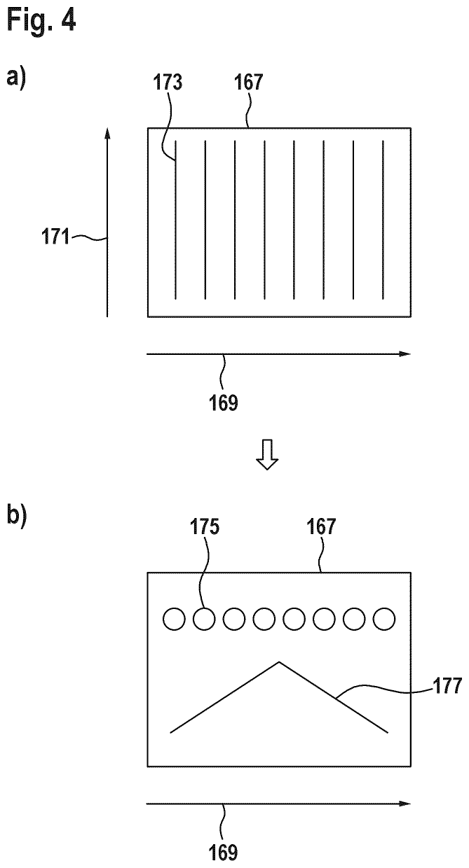

FIG. 4 shows a schematic illustration of a measurement by the measuring device 100 according to one embodiment.

For pre-processing, the radar data 103 or the additional sensor information 104 of the remaining sensors may be normalized, in particular to numerically stabilize the subsequent steps performed by the diagnostic module 107 during the wall diagnostics. For example, an amplitude and/or offset compensation may be performed for this purpose. Moreover, to reduce interference, filtering of the radar data 103 may be carried out, and to reduce the data rate, the corresponding sensor data may be sampled. Additionally, the radar data 103 or the additional sensor information 104 may be transformed into the respectively required frequency range or time range. Methods known from prior art can be used for this purpose.

Furthermore, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement by the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more sampling points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data may comprise the respective pre-processed sensor data, i.e. radar data 103 and additional sensor information 104 of the additional sensors.

As stated above, the wall diagnostics may be performed by the diagnostic module 107 based on a correspondingly trained artificial intelligence. Alternatively, different processing paths may also be calculated by way of rule-based algorithms. In addition, within a processing path 102, a combination of artificial intelligence and rule-based algorithm is possible in the form of a parallel operation or concatenation.

The diagnostic results 109 of the wall diagnostics may be expressed as numeric values, vectors, or matrices. Furthermore, for the object detection, the probability of detection, or for the wall type classification and/or the object classification, respectively, a probability of the specified object classes and/or wall type classifications can be indicated. The same may apply to the position and/or depth determination, for which corresponding probability values can also be indicated.

In addition to the radar data 103, if the additional sensor information of the further sensor types is processed in a processing path 102, these may either be merged within the artificial intelligence 125 or combined by way of rule-based combinations.

During the post-processing of each processing path 102, of the embodiment in FIG. 3, multiple algorithm results based on multiple windows 167 may be summarized by the summary module 165. This summary can in particular be realized by way of majority formation, sum formation or also by multiplication of successive probability values.

Furthermore, by clustering multiple results, for example, it is possible to detect which objects, of multiple detected objects located close to one another, are the same object so that they are not incorrectly detected multiple times.

Likewise, it is possible to multiplicatively apply a weighting function 177 when summarizing the results from multiple windows 167. Advantageously, the diagnostic partial results 175 corresponding to corresponding data points in the space may be weighted with respect to positioning of the diagnostic partial results 175 relative to a center point of the respective window 167. This is illustrated by way of example in graph b), in which the individual diagnostic partial results 175 are weighted according to the weighting function 177 shown with respect to the center point of the window 167 shown.

According to one embodiment, the results of one processing path 102 after post-processing 163 may influence the extension of another processing path 102. Weighting parameters may be adjusted that may depend on the particular result from the processing path 102 for each window.

For example, the result of an object classification in which the object type 117 of an object located in the wall 105 is defined, can be used to increase the weight of a wall type classification, in which the wall type 123 of the respective wall 105 is determined, during the post-processing at locations without objects 113, because the respective radar data 103 at these locations is less influenced by reflections of the objects 113.

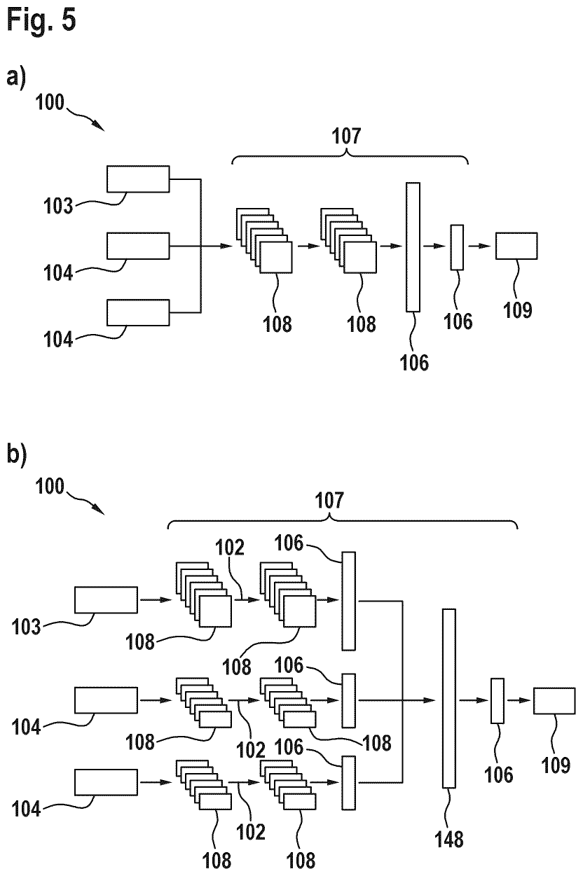

FIG. 5 shows a further schematic representation of the measuring device 100 according to a further embodiment.

Graphs a) and b) of FIG. 5 show two different alternatives of joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107 based on this.

On the other hand, in graph b) the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnostics of the different processing paths 102 are combined and fed to a final dense layer 106. The output data of the diagnostic module 107 corresponds to the diagnostic results 109 described above.

The correspondingly configured diagnostic module 107 is configured to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from prior art.

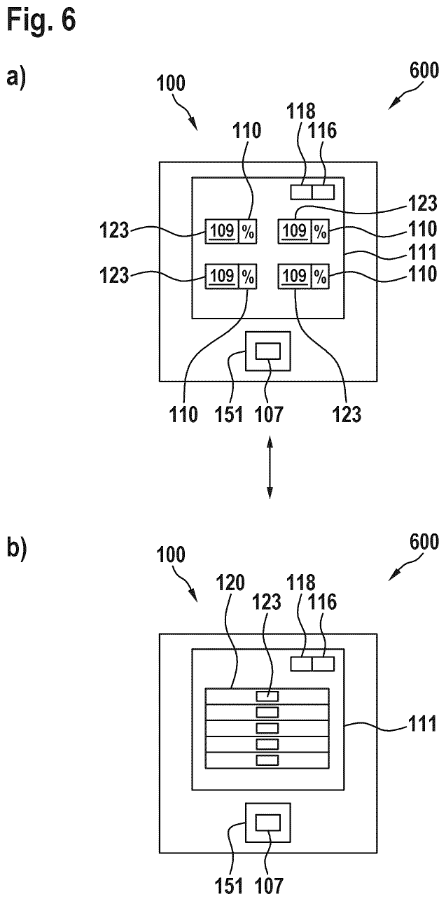

FIG. 6 shows a schematic representation of a system 600 for operating a measuring device 100 according to one embodiment.

In the embodiment shown, the system 600 comprises at least the measuring device 100 including the diagnostic module 107.

According to the disclosure, at least one wall type classification based on the radar data 103 is performed by the diagnostic module 107 to carry out the wall diagnostics, and at least the wall type 123 of the wall 105 is determined. The respective wall type 123 is provided to the display unit 111 as a diagnostic result 109 and is displayed thereon.

In addition to the wall type 123, the object position 115 and/or the object type 117 and/or the object depth 119 and/or the object extension 121 can also be determined as the corresponding diagnostic result 109 in the wall diagnostics.

In the embodiment shown, an uncertainty value 110 is further determined by the diagnostic module 107 for each determined diagnostic result 109. The uncertainty value describes a probability value that the respective diagnostic result 109 reflects the actual state of the wall 105 to be examined. In the embodiment shown, the uncertainty value 110 thus defines the probability value that the indicated wall type 123 corresponds to the actual wall type 123 of the wall 105 to be examined.

In the embodiment shown, a plurality of possible wall types 123 are determined by the diagnostic module 107 during wall diagnostics. The determined wall types 123 are each shown as stand-alone diagnostic results 109 in the display unit 111. Each possible wall type determined is provided with a corresponding uncertainty value 110.

The diagnostic module 107 is configured to calculate the respective probability value for each of the determined possible wall types 123 based on the wall diagnostics performed.

According to the embodiment shown in graph a), the measuring device 100 further provides a first selection function 116 and a second selection function 118. By way of the first selection function 116, the user can select a diagnostic result 109 to be considered for further wall diagnostics among the plurality of diagnostic results 109, for example among the plurality of wall types 123 shown. The unselected diagnostic results 109 are thus disregarded for further wall diagnostics. In the embodiment shown, the user can thus select one of the plurality of possible wall types 123 displayed for further wall diagnostics via the first selection function 116.

The second selection function 118, on the other hand, allows the user to deactivate the automatic wall type determination. The user may further manually input a wall type 123, on which the further wall diagnostics are to be performed.

According to one embodiment, in the event that a wall type 123 was manually input by the user via the second selection function 118, the diagnostic module 107 is configured to determine an uncertainty value 110 for this wall type 123 based on the wall diagnostics. Furthermore, based on the determined uncertainty value 110, the diagnostic module 107 is configured to take into account the wall type 123 manually entered by the user for further wall diagnostics if the determined uncertainty value 110 reaches or exceeds a predefined threshold value. On the other hand, if the determined uncertainty value 110 of the wall type 123 selected by the user does not reach the predefined threshold value, this can be indicated to the user on the display unit 111. In this case, for example, the user may be shown one of the wall types 123 automatically determined during wall diagnostics as a possible wall type. Alternatively, several of the determined wall types 123 can also be displayed to the user. For further wall diagnostics, one of the automatically determined wall types 123, preferably the one with the highest uncertainty value 110, can be considered.

Graph b) shows another embodiment for actuating the second selection function 118. When deactivating the automatic wall type determination by actuating the second selection function 118, a plurality of pre-saved wall types 123 can be displayed to the user as an alternative or in addition to the possibility of the user manually entering a wall type 123. The user can thus select one of the possible wall types 123 stored, for example, in a database 120.

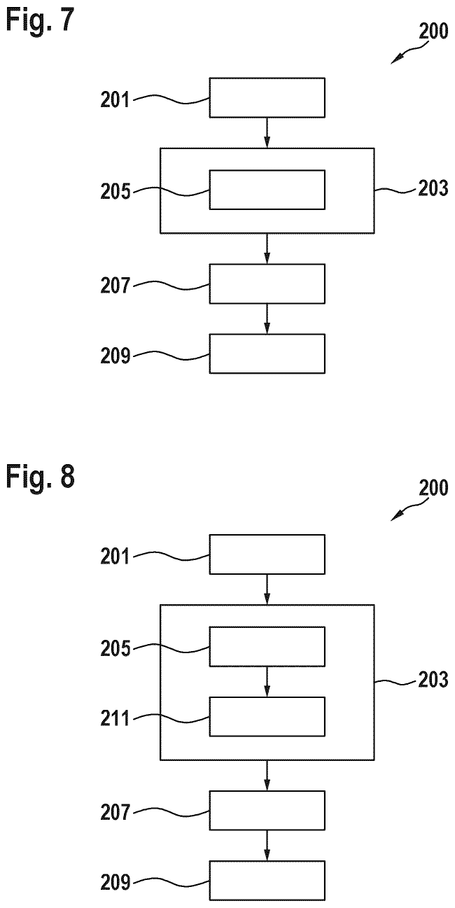

FIG. 7 shows a flowchart of a method 200 for operating a measuring device 100 according to one embodiment.

To operate the measuring device 100, in a method step 201, radar data 103 of the radar sensor unit 101 of the measuring device 100 is first received. The radar data 103 depicts the wall 105 on which diagnostics are to be performed.

In another method step 203, wall diagnostics are performed by the diagnostic module 107 based on the radar data 103, and diagnostic results 109 are provided.

For this purpose, in a method step 205, a wall type classification is performed and a wall type 123 of the wall 105 is determined by the diagnostic module 107.

In another method step 207, the diagnostic results are provided to the display unit 111 by the diagnostic module 107.

In a method step 209, the diagnostic results 109 are displayed in the display unit 111.

FIG. 8 shows another flowchart of the method 200 for operating a measuring device 100 according to a further embodiment.

The embodiment shown in FIG. 8 is based on the embodiment in FIG. 7 and comprises all the method steps described there.

In the embodiment shown, in a method step 211, during wall diagnostics, uncertainty values 110 of the diagnostic results 109 are determined by the diagnostic module 107. The uncertainty values 110 describe probability values that the diagnostic results 109 match the actual state of the wall 105 to be examined.

In method steps 207 and 209, the uncertainty values determined in method step 211 with the corresponding diagnostic results 109 are provided to and displayed in the display unit 111.

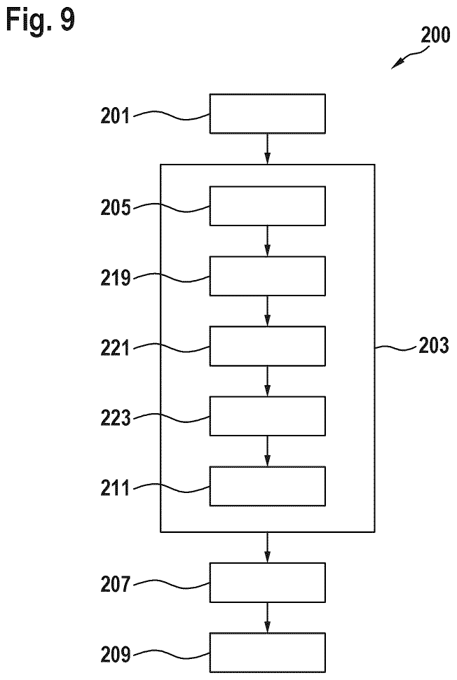

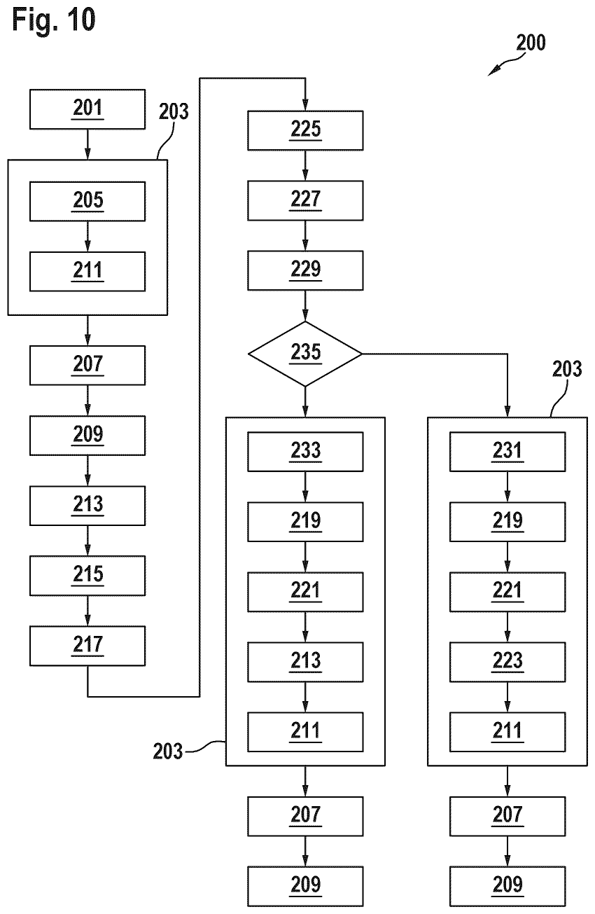

FIG. 9 shows another flowchart of the method 200 for operating a measuring device 100 according to a further embodiment.

The embodiment shown in FIG. 9 is based on the embodiment in FIG. 8 and comprises all the method steps described there.

In the embodiment shown, in a method step 219, during the course of wall diagnostics, an object detection of the at least one object 113 disposed in the wall 105 is performed with the object detection including the determination of the object position 115 and the object classification including the determination of the object type 117.

In a further method step 221, the object depth determination is performed and the object depth 119 of the object 113 is determined.

In a method step 223, the object extension determination is performed and the object extension 221 of the object 113 is determined.

The object position 115 and/or the object type 117 and/or the object depth 119 and/or the object extension 121 are provided as corresponding diagnostic results 109 of the display unit 111 and displayed thereon. For the object position 115 and/or the object type 117 and/or the object depth 119 and/or the object extension 121, corresponding uncertainty values 110 are calculated and shown on the display unit 111.

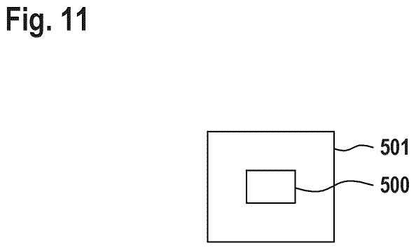

FIG. 10 shows another flowchart of the method 200 for operating a measuring device 100 according to a further embodiment.

The embodiment shown in FIG. 10 is based on the embodiment in FIG. 8 and comprises all the method steps described there.

According to the embodiment shown, a plurality of possible alternative results is provided by the diagnostic module 107 during the wall diagnostics as a diagnostic result 109. For example, multiple different possible wall types 123 are determined and may be displayed on the display unit 111. The plurality of wall types 123 are provided with corresponding uncertainty values 110. The same applies to the object position 115, the object type 117, the object depth 119 and the object extension 121, for which several possible alternative values including the uncertainty values 110 can also be determined.

In a further method step 213, a first selection function 116 is provided. By activating the first selection function 116, at least one of the plurality of possible wall types 123 indicated may be selected.

Furthermore, in a method step 215, a second selection function 118 is provided. By activating the second selection function 118, the automatic determination of the wall type 123 may be deactivated. In addition, a wall type 123 is manually selectable by the user.

In a further method step 217, the plurality of possible wall types 123 is displayed in the second selection function 118. The user may select at least one of the displayed wall types 123 by activating the second selection function 118.

In a further method step 225, selection commands of the user are received by the measuring device 100, wherein a wall type 123 is selected by the selection commands.

In a further method step 227, a corresponding uncertainty value in the form of a probability value is ascertained or determined for the selected wall type 123.

In a further method step 229, the wall type 123 for which the greater probability value was determined based on the radar data 103 is displayed in the display unit if the probability value of the wall type 123 selected by the user falls below a predetermined threshold value.

In a further method step 235, the probability values of the determined wall types 123 are checked.

In a further method step 231, the wall type 123 selected by the user in the second selection function 118 is considered for further wall diagnostics if the probability value of the selected wall type 123 reaches or exceeds the predefined limit value.

If the probability value of the selected wall type does not reach the predetermined limit value, then, in a further method step 233, a wall type 123 determined during the automatic determination of the wall type 123 with the greatest uncertainty value 111 is considered for the further wall diagnostics.

FIG. 11 shows a schematic representation of a computer program product 500 comprising instructions that, when the program is executed by a data processing unit, cause the latter to perform the method 200 for operating a measuring device 100.

In the embodiment shown, the computer program product 500 is stored on a storage medium 501. The storage medium 501 can, in this case, be any desired storage medium known from prior art.

What is claimed is:

1. A computer-implemented method of operating a measuring device, comprising:
receiving radar data of a radar sensor unit of the measuring device, wherein the radar data depicts a wall on which diagnostics are to be performed; and
performing wall diagnostics by performing an analysis of the radar data and providing diagnostic results by a diagnostic module of the measuring device, wherein the performing wall diagnostics comprises:
performing a wall type classification and determining a wall type of the wall by way of the diagnostic module, wherein the diagnostic results comprise at least the wall type of the wall;
providing the diagnostic results by the diagnostic module to a display unit of the measuring device; and
displaying the diagnostic results in the display unit.

2. The method according to claim 1, wherein:
the performing wall diagnostics further comprises determining uncertainty values of the diagnostic results by the diagnostic module,
the uncertainty values of the diagnostic results describe probability values that the diagnostic results match an actual state of the wall on which diagnostics are performed, and comprise at least one probability value of the wall type of the wall, and
wherein the method further comprises (i) providing the uncertainty values together with the diagnostic results by the diagnostic module to the display unit, and (ii) displaying the uncertainty values along with the diagnostic results in the display unit.

3. The method according to claim 1, wherein:
a plurality of possible wall types of the wall will be determined as stand-alone diagnostic results in the wall type classification,
a probability value is determined for each of the plurality of wall types of the wall, and
the plurality of wall types of the wall are displayed as diagnostic results and the plurality of probability values of the different wall types are displayed as corresponding uncertainty values of the diagnostic results in the display unit.

4. The method according to claim 3, further comprising:
providing a first selection function, wherein at least one of the displayed wall types is selectable by performing the first selection function by a user of the measuring device.

5. The method according to claim 3, further comprising:
providing a second selection function, wherein, by the user of the measuring device performing the second selection function, automatic determination of the wall type during wall diagnostics and/or display of the wall type in the display unit is deactivated, and a wall type is manually selectable by the user.

6. The method according to claim 5, further comprising:
displaying a plurality of possible wall types in the second selection function, wherein the user is able select at least one of the displayed possible wall types in the second selection function.

7. The method according to claim 1, wherein the performing wall diagnostics further comprises:
performing an object recognition of an object located in the wall using the diagnostic module, wherein the object recognition comprises an object detection and an object classification, and wherein the diagnostic results comprise at least one object position in the wall and/or one object type of the object; and/or
performing an object depth determination and determining an object depth of the object in the wall using the diagnostic module, wherein the object depth is defined as a distance of the object to a surface of the wall; and/or
performing, by way of the diagnostic module, an object extension determination and determining an object extension of the object along a predefined direction, wherein the diagnostic results further comprise the object position in the wall and/or the object type and/or the object depth and/or the object extension of the object, and wherein the uncertainty values further comprise at least one probability value of the object position and/or a probability value of the object type and/or a probability value of the object depth and/or a probability value of the object extension of the object.

8. The method according to claim 5, further comprising:
receiving selection commands from the user, wherein a wall type is selected by the user in the first or second selection function by the selection commands;
determining, by way of the diagnostic module, the probability value of the selected wall type based on the radar data; and
displaying the wall type for which the greatest probability value was determined based on the radar data if the probability value of the wall type selected by the user falls below a predetermined threshold value; and/or
considering the wall type selected by the user in the second selection function for object recognition and/or object depth determination and/or object extension determination if the probability value of the selected wall type reaches or exceeds the predefined limit value; and/or
considering, by way of the diagnostic module, the automatically determined wall type based on the radar data with the greatest probability value for object recognition and/or object depth determination and/or object extension determination.

9. The method according to claim 1, wherein object classes of the object type of the object comprise: metallic/non-metallic object, low voltage cable, single phase AC signal cable, multiphase AC signal cable, wood beam, metal beam, plastic pipe, water filled plastic pipe, non-water filled plastic pipe, and/or wherein the wall type classes of the wall type of the wall comprise: concrete wall, plasterboard/drywall wall, brick wall and/or bricks of the wall, underfloor heating, wall heating.

10. The method according to claim 1, wherein:
the measuring device further comprises at least one of an induction sensor and/or an eddy current sensor and/or a capacitance sensor and/or an AC current sensor and/or an NMR sensor and/or an ultrasonic sensor for providing additional sensor data, and
the diagnostic module is configured to perform the wall diagnostics by taking into account the additional sensor data.

11. The method according to claim 1, wherein the diagnostic module comprises at least one correspondingly trained artificial intelligence configured to perform object detection and/or a wall classification and/or an object depth determination and/or an object extension determination based on the radar data and/or the additional sensor data.

12. A computing unit configured to perform the method for operating a measuring device according to claim 1.

13. A computer program product comprising instructions which, when the program is executed by a data processing unit, cause the data processing unit to perform the steps of the method for operating a measuring device according to claim 1.

14. The method according to claim 1, wherein the measuring device is a wall diagnostic device.

15. The method according to claim 9, wherein:
the water filled plastic pipe includes a fresh water pipe, and
the non-water filled plastic pipe includes a waste water pipe.
